(19) United States
(12) Patent Application Publication
(10) Pub. No.: US 2015/0021185 A1
(43) Pub. Date: Jan. 22, 2015

(54) CAPACITIVE DEIONIZATION APPARATUS AND METHODS OF TREATING FLUID USING THE SAME

(71) Applicant: Samsung Electronics Co., Ltd., Suwon-Si (KR)

(72) Inventors: Da Hye PARK, Hwaseong-si (KR); Myung Dong CHO, Hwaseong-si (KR); Hyo Rang KANG, Anyang-si (KR); Hyun Seok KIM, Suwon-si (KR); Joon Seon JEONG, Seoul (KR)

(21) Appl. No.: 14/321,011

(22) Filed: Jul. 1, 2014

(30) Foreign Application Priority Data
Jul. 22, 2013 (KR) 10-2013-0086111

(51) Int. Cl. C02F 1/469

(52) U.S. Cl. CPC C02F 1/4691
USPC 204/554; 204/674

(57) ABSTRACT

An electrode material may include a porous carbon material and an organic clay. An electrode for a capacitive deionization apparatus may include the electrode material. A method of removing ions from a fluid may include using the capacitive deionization apparatus.

### CROSS-REFERENCE TO RELATED APPLICATION

This application claims priority under 35 U.S.C. §119 to Korean Patent Application No. 10-2013-0086111, filed in the Korean Intellectual Property Office on Jul. 22, 2013, the entire contents of which are incorporated herein by reference.

### BACKGROUND

1. Field

The present disclosure relates to a capacitive deionization apparatus and/or a water treatment method using the same.

2. Description of the Related Art

In some regions, domestic water may include a relatively large amount of minerals. For instance, in Europe or other regions, limestone substances frequently flow in underground water, and thus tap water in these regions contains a relatively large amount of minerals. Water having a relatively high mineral content (i.e., hard water) may cause problems such as the occurrence of lime scales in the interior walls of pipes and a sharp decrease in energy efficiency when hard water is used for home installations, for example, in a heat exchanger or a boiler. In addition, hard water is inappropriate for use as wash water. Therefore, there has been a demand for technology for removing ions from hard water to make it into soft water, in particular, in an environmentally-friendly manner. Furthermore, demands for seawater desalination have increased as larger areas are suffering from water shortages.

A capacitive deionization (CDI) apparatus is a device that applies a voltage to polarize porous electrodes having nano-sized pores. As a result, ionic materials are adsorbed from a medium such as hard water onto the surface of the electrodes and thus removed from the medium. In the CDI apparatus, when a medium containing dissolved ions flows between two electrodes of an anode and a cathode and DC power having a low potential difference is applied thereto, the anionic components and the cationic components among the dissolved ions are adsorbed and concentrated onto the anode and the cathode, respectively. When an electric current flows in a reverse direction between the two electrodes by, for example, short-circuiting the two electrodes, the concentrated ions are desorbed from the electrodes. Since the CDI apparatus does not require a high potential difference, its energy efficiency is relatively high, harmful ions may be removed together with the hard components when the ions are adsorbed, and its recycling process does not need any chemicals.

### SUMMARY

Some example embodiments relate to an electrode material for a capacitive deionization apparatus capable of improving deionization efficiency.

Some example embodiments relate to an electrode for a capacitive deionization apparatus, wherein the electrode includes the electrode material for a capacitive deionization apparatus.

Some example embodiments relate to a capacitive deionization apparatus including the electrode.

Some example embodiments relate to a method of removing ions from a fluid using the capacitive deionization apparatus.

An electrode material for a capacitive deionization (CM) apparatus may include a porous carbon material and an organic clay within the porous carbon material.

The porous carbon material may include at least one selected from activated carbon, an aerogel, carbon nanotubes (CNT), mesoporous carbon, activated carbon fiber, and graphite oxide.

The organic clay may include a layered structure having a cation exchange capacity. The organic clay may be modified with a water-soluble organic material having an ion exchange functional group.

The organic clay is a phyllosilicate including a tetrahedral silicate bonded on a secondary base sheet and may be a smectite-based clay, a vermiculite-based clay, or mica, which may be modified with an organic material having a cation exchange group or an anion exchange group.

The cation exchange group may be a sulfonic acid group, a carboxyl group, a phosphonic group, a phosphinic group, an arsenic group, a selenonic acid group, and the like.

The anion exchange group may be a quaternary ammonium salt (—NR₃), a primary amine (—NH₂), a secondary amine (—NHR), a tertiary amine (—NR₂), a quaternary phosphonium group (—PR₄), a tertiary sulfonium group (—SR₃), and the like.

A content of the organic clay in the electrode material may be less than or equal to about 40 wt %.

The electrode material may further include a conductive material and/or an ion conductive binder.

The conductive material may be at least one selected from a carbon-based material selected from carbon black, VGCF (vapor growth carbon fiber), natural graphite, artificial graphite, acetylene black, ketjen black, and a carbon fiber; a metal powder or a metal fiber selected from copper, nickel, aluminum, and silver; a conductive polymer; and a mixture thereof.

The binder may include at least one selected from polystyrene, polyvinyl alcohol, carboxylmethyl cellulose, hydroxypropyl cellulose, polyvinyl chloride, carboxylated polyvinyl chloride, polyvinyl fluoride, polyamide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, polyacrylamide, and a mixture thereof.

An electrode for a capacitive deionization apparatus may include the electrode material.

The electrode may be a cathode or an anode for a capacitive deionization apparatus.

The electrode may further include an ion exchange polymer coating layer on a surface of the electrode.

The ion exchange polymer may be a polymer including a cation exchange group selected from a sulfonic acid group (—SO₃H), a carboxyl group (—COOH), a phosphonic group (—PO₃H₂), a phosphinic group (—HPO₃H), an arsenic group (—AsO₃H₂), and a selenonic acid group (—SeO₃H) at a main chain or a side chain of the polymer. The polymer may be at least one selected from polystyrene, polyvinyl alcohol, carboxylmethyl cellulose, hydroxypropyl cellulose, polyvinyl chloride, carboxylated polyvinyl chloride, polyvinyl fluoride, polyamide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, polyacrylamide, and a mixture thereof. The ion exchange polymer may be also be a polymer including an anion exchange group selected from a quaternary ammonium salt (—NR₃), primary to tertiary amine groups (—NH₂, —NHR, and —NR₂), a quaternary phosphonium group (—PR₄), and a tertiary sulfonium group (—SR₃) at a main chain or a side chain of the polymer.

A capacitive deionization apparatus may include the electrode discussed herein.

The deionization apparatus includes a cathode (or an anode) including the electrode material for a capacitive deionization apparatus, an anode (or a cathode) facing the cathode (or the anode), and a spacer disposed between the cathode and the anode.

The spacer may have an open mesh, non-woven fabric, woven fabric, or foam shape.

The deionization apparatus may further include a charge barrier disposed between the electrode and the spacer. The charge barrier includes a different material from the electrode material.

A method of removing ions from a fluid includes using the capacitive deionization apparatus. The method may include providing a capacitive deionization apparatus including the electrode, another electrode facing the electrode, and a spacer disposed between the electrodes; and applying a voltage to the electrodes while supplying an ion-containing fluid into the capacitive deionization apparatus.

The method of treating the fluid may further include desorbing ions adsorbed on the electrodes by short-circuiting the electrodes or applying a reverse voltage to the electrodes.

### BRIEF DESCRIPTION OF THE DRAWINGS

FIG. 1 is a schematic view showing the cross-section of an electrode manufactured by using an electrode material including a porous carbon material and an organic clay according to one example embodiment of the present disclosure and a moving passage of ions adsorbed from a fluid.

FIG. 2 is a schematic view showing examples of a capacitive deionization apparatus according to non-limiting embodiments of the present disclosure.

FIG. 3 is a graph showing ion conductivity experiment results of an electrode manufactured by mixing a binder with a carbon material (Comparative Example 1), an electrode manufactured by mixing organic clay with a carbon material according to Example 2, and an electrode manufactured by mixing organic clay with a carbon material and additionally coating an ion exchange material on the surface of the electrode according to Example 4.

FIG. 4 is a graph showing comparison of ion removal rates of the capacitive deionization apparatuses manufactured by varying the amount of organic clay according to Examples 1 to 3.

FIG. 5 is a graph showing ion removal rates of an electrode including organic clay according to Example 1 and an electrode including conventional clay (montmorillonitrile) according to Comparative Example 2.

### DETAILED DESCRIPTION

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As used herein, the term “capacitive deionization apparatus” refers to a device that may separate/concentrate ions by passing fluids to be separated or to be concentrated including at least one ion component through a flow path formed between at least one pair of porous electrodes and applying a voltage thereto so as to adsorb the ion components on the pores in the electrodes. The “capacitive deionization apparatus” may have any geometric structure.

As used herein, the term “porous electrode” refers to a conductive structure including an electrically-conductive material, for example a porous carbon material, and having a high specific surface area due to the presence of pores therein having a diameter of nanometers or larger, for example, about 0.5 nm to about 5 μm.

As used herein, “ion exchange polymer” may refer to a polymer including an ion exchange group in the main chain or the side chain of the polymer.

Some example embodiments relate to an electrode material (for a capacitive deionization (CM) apparatus) including a porous carbon material and an organic clay.

The porous carbon material may include at least one selected from activated carbon, an aerogel, carbon nanotubes (CNT), mesoporous carbon, activated carbon fiber, and graphite oxide.

As defined above, the porous carbon material has a relatively high specific surface area due to the presence of pores therein having a diameter of nanometers or larger, for example, about 0.5 nm to about 5 μm, and therefore absorbs ions to be removed from the fluid through the pores.

The organic clay is clay that includes a layered structure having cation exchange capacity and is modified with a water-soluble organic material having an ion exchange functional group.

The organic clay is a phyllosilicate including a tetrahedral silicate bonded on a secondary base sheet, and may be prepared using smectite-based clay, vermiculite-based clay, or mica. Specifically, the smectite-based clay may be montmorillonite, saponite, baidelite, hectorite, stibnite, and the like, the vermiculite-based clay may be vermiculite, and the mica may be muscovite, phologopite, and the like.

The organic clay may be the phyllosilicate-type clay modified with an organic material having a cation exchange group or an anion exchange group. The cation exchange group may be a sulfonic acid group, a carboxyl group, a phosphonic group, a phosphinic group, an arsenic group, a selenonic acid group, and the like. The anion exchange group may be a quaternary ammonium salt (—NR₃), a primary amine (—NH₂), a secondary amine (—NHR), tertiary amine (—NR₂), a quaternary phosphonium group (—PR₄), or a tertiary sulfonium group (—SR₃), but are not limited thereto.

The phyllosilicate-type organic clay is known to have cation exchange performance. For example, tetrahedral and octahedral silicate are present in a ratio of 2:1 in smectite-based clay, in which alumina is partly substituted with silica in the tetrahedral silicate, iron or magnesium is substituted with aluminum in the octahedral silicate, and thus the smectite-based clay lacks cations and adsorbs cations to compensate for this cation shortage.

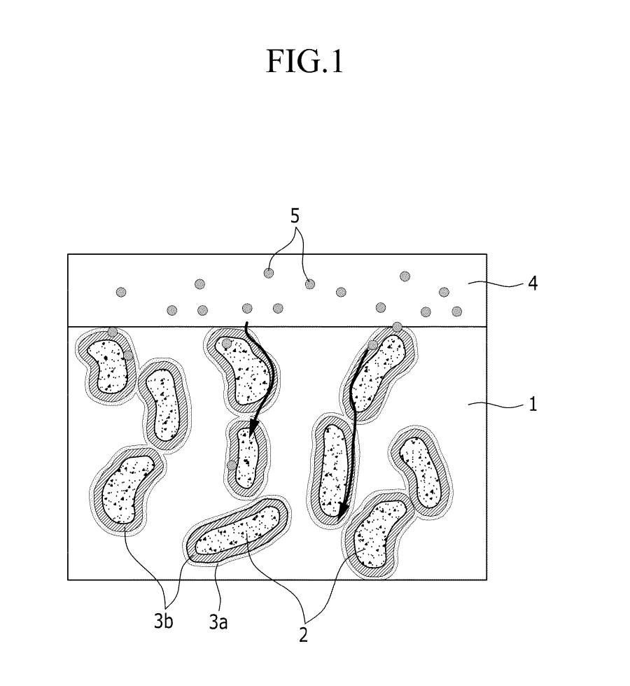

In this way, when clay having ion exchange or adsorption performance is modified by a water-soluble organic material having an ion exchange functional group, this organic material has a hydration structure containing a solvent on the surface of the clay in a slurry and plays a role in forming holes in an electrode. In particular, the solvent in the electrode material is dried and leaves holes when casting the slurry into the electrode. The pores formed by the organic material provide a path through which ions move faster during operation of a capacitive deionization (CDI) apparatus and may improve ion exchange performance of the electrode. FIG. 1 schematically shows the ion movement. Referring to FIG. 1, when an electrode material for a capacitive deionization (CDI) apparatus includes an organic clay 2 in a porous carbon material 1, the surface of the organic clay 2 may be modified by a water-soluble organic material 3a. This water-soluble organic material 3a includes pores 3b left when a solvent included in the organic material is evaporated after casting the water-soluble organic material 3a into an electrode. Thus, ions 5 adsorbed from the fluid 4 move faster through the pores 3b in the water-soluble organic material 3a. Accordingly, an electrode for a capacitive deionization (CDI) apparatus including the electrode material according to an example embodiment shows much improved ion exchange performance.

The organic clay may be commercially available and includes synthetic or natural organic clay. The synthetic organic clay may be obtained by mixing the material having a cation exchange group or an anion exchange group with the phyllosilicate clay, agitating the mixture, and filtering and washing the resultant.

For example, the organic clay may be prepared by reacting organic onium ions with an aqueous slurry of the phyllosilicate clay. The organic onium ions are formed from a compound prepared by coordinating a compound present as protons or other cations with a compound including an element having lone pair electrons such as oxygen, sulfur, and nitrogen. These organic onium ions may include anything capable of thickening and being dispersed in a liquid substituting inorganic ions of a layered clay mineral with organic onium ions, for example, ammonium ions, phosphonium ions, oxo-aluminum ions, sulfonium ions, and the like.

The clay has a layered structure and thus may be expanded due to water and help to secure a path for ion movement. When this clay is modified by a water-soluble organic material having an ion exchange functional group, the organic material may play a role of an electrolyte as well as improve wettability of carbon used as an active material for an electrode due to hydrophilicity and thus contribute to increased reversible capacity of the electrode.

Furthermore, the clay material has an effect on improving mechanical strength compared with an electrode material including no clay material during manufacture of an electrode. In addition, an electrode material including organic clay develops almost no cracks when cast and dried.

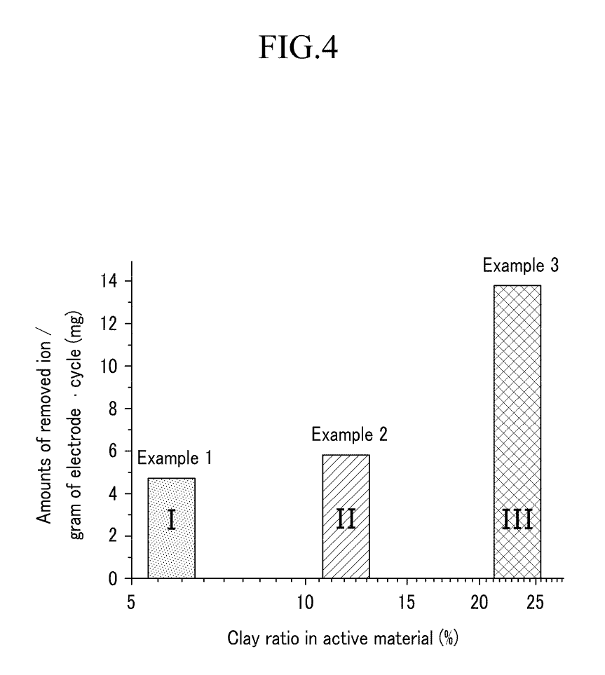

The electrode material may include organic clay in a non-zero amount of less than or equal to about 40 wt %. When the organic clay is included in an amount of greater than about 40 wt %, the capacity of an electrode no longer increases, but an ion removal effect decreases. However, as shown in FIG. 4, when the organic clay is included in an amount of less than or equal to about 40 wt %, the amount of ions removed per cycle increases as the amount of the organic clay is increased.

The electrode material may further include a conductive material to reinforce conductivity of the electrode. The conductive material may be any material used for an electrode without a particular limit. As non-limiting examples, the conductive material may be selected from a carbon-based material such as carbon black, VGCF (vapor growth carbon fiber), natural graphite, artificial graphite, acetylene black, ketjen black, a carbon fiber, and the like; copper, nickel, aluminum, silver, and the like; a metal-based material such as a metal powder or a metal fiber and the like; a conductive polymer such as a polyphenylene derivative and the like; and a mixture thereof.

The conductive material may be included in an amount of less than or equal to about 30%, specifically about 0.1% to about 30%, and more specifically about 1% to about 20% based on the entire weight of an electrode material.

Electrodes are connected to one another and form a consecutive structure, and in addition, they may further include a binder adhering the electrode material to a current collector

The binder has no particular limit as to the kind, and may include any conventional binder used to manufacture an electrode. Non-limiting examples of the general binder may be polystyrene, polyvinyl alcohol, carboxylmethyl cellulose, hydroxypropyl cellulose, polyvinyl chloride, carboxylated polyvinyl chloride, polyvinyl fluoride, polyamide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, polyacrylamide, and a mixture thereof.

The binder may be included in an amount of less than or equal to about 20%, for example, about 0.1% to about 20%, or as another example about 1% to about 10%, based on the total amount of the electrode material.

An electrode for a capacitive deionization apparatus may include the electrode material.

The electrode may be an anode or a cathode. When the electrode is an anode, it may have an anion exchange group. On the other hand, and when the electrode is a cathode, it may have a cation exchange group.

The thickness of the electrode may not be particularly limited, and may be selected within an appropriate range. For example, the thickness of the electrode may be about 50 μm to about 500 μm, and specifically about 100 μm to about 300 μm.

The electrode may be manufactured by coating the electrode material on a current collector. When including multiple pairs of electrodes, both sides of the current collector may be combined with the electrodes, respectively. The current collector is electrically connected to a power source, thereby applying a voltage to the electrodes. The current collector may include a graphite plate or a graphite foil, or at least one metal selected from copper (Cu), aluminum (Al), nickel (Ni), iron (Fe), cobalt (Co), and titanium (Ti), a metal mixture, or an alloy thereof.

The electrode may be manufactured by additionally coating an ion exchange polymer on a surface of the electrode material coated on the current collector.

The ion exchange polymer may be a polymer including a cation exchange group selected from a sulfonic acid group (—SO₃H), a carboxyl group (—COOH), a phosphonic group (—PO₃H₂), a phosphinic group (—HPO₃H), an arsenic group (—AsO₃H₂), and a selenonic acid group (—SeO₃H) at a main chain or a side chain of the polymer, or a polymer including an anion exchange group selected from a quaternary ammonium salt (—NR₃), primary to tertiary amine groups (—NH₂, —NHR, or —NR₂), a quaternary phosphonium group (—PR₄), and a tertiary sulfonium group (—SR₃) at a main chain or a side chain of the polymer. The polymer (which may be the above generally-used binder polymer) may be synthesized using an appropriate method, or may be commercially available products.

A capacitive deionization apparatus may include the electrode discussed above.

The deionization apparatus includes a cathode (or an anode) including the electrode material, an anode (or a cathode) facing the cathode (or the anode), and a spacer disposed between the cathode and the anode.

In an example embodiment, the electrode including the electrode material may be a cathode. Herein, the electrode for the capacitive deionization apparatus (e.g., a cathode) may be as described above and further description thereof is omitted in the interest of brevity.

When the electrode including the electrode material is a cathode, an anode for the capacitive deionization apparatus may be any generally-used anode for a capacitive deionization apparatus. For example, the anode may be manufactured by mixing a solution of a polymer having an anion exchange group such as an amine group and the like, with a porous carbon material such as activated carbon and the like, and the above conductive material and binder, coating the same on a current collector, and casting and drying the same.

The spacer disposed between the pair of electrodes may form a path (i.e., a flow path) for flowing a fluid between the electrodes. The spacer includes an electrically insulative material and, thus, prevents a short-circuit between the electrodes.

The spacer may be formed of any material for forming a flow path and preventing an electrode short-circuit, and may have any structure. As a non-limiting example, the spacer may have an open mesh, non-woven fabric, woven fabric, or foam shape. As a non-limiting example, the spacer may include polyesters such as polyethylene terephthalate and the like; polyolefins such as polypropylene, polyethylene, and the like; polyamides such as nylon and the like; an aromatic vinyl-based polymer such as polystyrene; a cellulose derivative such as cellulose, methyl cellulose, acetylmethyl cellulose, and the like; a polyetherether ketone; a polyimide; polyvinyl chloride; or a combination thereof. The thickness of the spacer is not particularly limited, but it may range from about 50 μm to about 500 μm, for example about 100 μm to about 300 μm in light of the flow amount and the solution resistance. The open area of the spacer may range from about 20% to about 80%, for example about 30% to about 50%, in light of the flow amount and the solution resistance.

The capacitive deionization apparatus may further include a charge barrier disposed between the spacer and the electrode. The charge barrier may be a cation permselective membrane or an anion permselective membrane. The cation or anion permselective membrane may be prepared by an appropriate method, or is commercially available. Examples of cation or anion permselective membranes which may be used in the capacitive deionization apparatus may include, but are not limited to, Neosepta CMX, Neosepta AMX, or the like manufactured by Tokuyama.

Conventionally, the ions in the fluid (e.g., water) may be removed by using a capacitive deionization apparatus at a relatively high efficiency when the concentration of ions to be removed is within a predetermined level (e.g., less than or equal to about 2000 ppm). However, when the ion concentration of the feed solution is relatively low, for example, 500 ppm or lower, such a low level of the ion concentration of water passing between the pair of electrodes results in a higher level of solution resistance applied in the flow channel. Thereby, a higher degree of voltage drop may occur in the flow channel. As a result, the driving voltage that may be used as a real driving force for the ion adsorption from the voltage applied to the pair of electrodes is sharply decreased, and this leads to lower efficiency for the adsorption. Thereby, it may be difficult to obtain a treated solution having a high purity of about 60 μS/cm or less of the ionic conductivity by using a conventional capacitive deionization apparatus.

In order to solve the aforementioned problem, there is an attempt in the conventional art to use a highly dense nanopore carbon electrode to increase efficiency at a given thickness as a method of increasing capacity of an electrode. However, the nanopore carbon electrode does not have a sufficient path for ions.

The capacitive deionization apparatus according to one example embodiment of the present disclosure includes an electrode formed of an electrode material including organic clay, and thus secures a path for ion movement in the electrode including the same amount of the electrode material and remarkably increases ion removal efficiency. In other words, an ion removal rate per unit is improved, and thus ion removal efficiency is improved. The capacitive deionization apparatus according to one example embodiment of the present disclosure shows ion exchange capacity ranging from about 0.01 meq/g to about 10 meq/g, and specifically about 0.1 meq/g to about 1 meq/g.

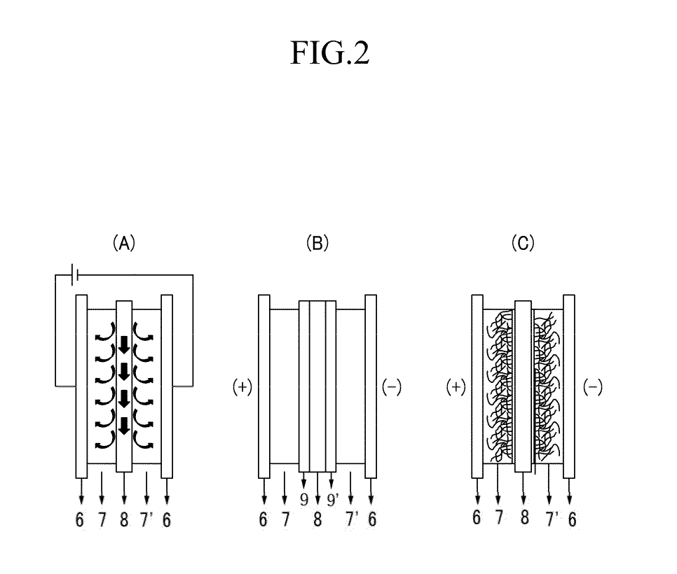

The capacitive deionization apparatus may have any geometric structure. By way of non-limiting examples, the capacitive deionization apparatus may have a schematic structure as shown in FIGS. 2(A) to (C). Hereinafter, the capacitive deionization apparatus will be explained with reference to the drawings.

Referring to FIG. 2(A), electrodes 7 and 7′ are respectively coated on current collectors 6, and a spacer 8 is interposed between the electrodes 7 and 7′ to provide a flow path. In the capacitive deionization apparatus shown in FIG. 2(B), the electrodes 7 and 7′ are respectively coated on current collectors 6, a spacer 8 is inserted between the electrodes 7 and 7′ to provide a flow path, and a cation permselective membrane 9′ and an anion permselective membrane 9 are interposed between the electrodes 7 and 7′ and the spacer 8. In addition, in the case of apparatus shown in FIG. 2(C), electrodes 7 and 7′ are respectively coated on current collectors 6, and a spacer 8 is interposed between the electrodes 7 and 7′ to define a flow path, wherein the electrode 7 is an anode using an anion exchange binder, and the electrode 7′ is a cathode using a cation exchange binder.

A method of removing ions from a fluid may include using the capacitive deionization apparatus discussed above.

Specifically, the method of treating the fluid includes providing a capacitive deionization apparatus including an electrode, another electrode facing the electrode, and a spacer disposed between the electrodes, and applying a voltage to the electrodes while supplying an ion-containing fluid into the capacitive deionization apparatus.

The method of treating the fluid may further include desorbing ions adsorbed in the electrodes by short-circuiting the electrodes or applying a reverse voltage to the electrodes.

The details of the capacitive deionization apparatus may be the same as described above.

The fluid including the ions, supplied into the capacitive deionization apparatus, is not particularly limited, but for example, it may be sea water, or it may be hard water containing calcium ions or magnesium ions. The rate of supplying the fluid is not particularly limited, but may be adjusted as required. For example, the rate may range from about 5 to about 50 ml/minute.

When a DC voltage is applied to the electrode while supplying the fluid, the ions present in the fluid are adsorbed onto the surface of the electrode. The applied voltage may be appropriately selected in light of the cell resistance, the concentration of the solution, or the like. For example, the applied voltage may be about 2.5 V or lower, and specifically, may range from about 1.0 V to about 2.0 V. When applying the voltage, the ion removal efficiency, as calculated from the measurement of the ion conductivity of the fluid, may be about 50% or higher, specifically, about 75% or higher, and more specifically, about 90% or higher.

The aforementioned capacitive deionization apparatus and the aforementioned methods may find utility in most home appliances using water, for example, a washing machine, a refrigerator, a water softener, or the like, and may also be used in an industrial water treatment device such as for seawater desalination and ultrapure water manufacture.

Hereinafter, several embodiments are illustrated in more detail with reference to the following examples. However, it is understood that the scope of the present disclosure is not limited to these examples.

### EXAMPLE

### 1) Manufacture of Electrode

### Example 1

### Manufacture of Organic Clay-Containing Cathode

0.2 g of an organic clay material (Nanofil 116, Songwon Specialty Co.), 3.2 g of activated carbon powder (a specific surface area=1600 m²/g), 0.6 g of carbon black (an average diameter=19 nm), and 4 g of a 5% binder aqueous solution including 0.2 g of a binder (polyvinyl alcohol) are mixed to prepare an electrode slurry, and the electrode slurry is coated to be 200 μm thick with reference to one side on a conductive graphite sheet (a thickness=380 μm) with a doctor blade and dried, manufacturing a cathode. The organic clay material is included in an amount of about 5.90% based on the total weight of the organic clay material and the activated carbon powder in the cathode material

### Example 2

### Manufacture of Organic Clay-Containing Cathode

A cathode is manufactured according to the same method as Example 1, except for using 0.4 g of the organic clay material (Nanofil 116, Songwon Specialty Co.) 3.0 g of the activated carbon powder (specific surface area=1600 m²/g). The organic clay material is included in an amount of about 11.80% based on the total weight of the organic clay material and the activated carbon powder in the cathode material.

### Example 3

### Manufacture of Organic Clay-Containing Cathode

A cathode is manufactured according to the same method as Example 1, except for using 0.8 g of the organic clay material (Nanofil 116, Songwon Specialty Co.) and 2.6 g of activated carbon powder (a specific surface area=1600 m²/g). The organic clay material is included in an amount of about 23.50% in the cathode material based on the total weight of the organic clay material and the activated carbon powder.

### Example 4

### Manufacture of Surface-Coated Organic Clay-Containing Cathode

A cathode is manufactured according to the same method as Example 2 by manufacturing an electrode by coating an electrode slurry on a conductive graphite sheet, and by further spin-coating a mixed solution of polyvinyl alcohol, sulfosuccinic acid, and sulfosalicylic acid in a concentration of 16.3 wt % on the surface of the electrode coated and dried on a current collector.

### Comparative Example 1

### Manufacture of Cathode without Organic Clay

A cathode is manufactured according to the same method as Example 4, except for including no organic clay, but using 3.4 g of activated carbon powder (a specific surface area=1600 m²/g).

### Comparative Example 2

### Manufacture of Cathode including Conventional Clay Rather than Organic Clay

A cathode is manufactured according to the same method as Example 1, except for using 0.2 g of conventional montmorillonite (Montmorillonite KSF. Sigma-Aldrich Co., Ltd.) rather than an organic clay as a clay material.

### Preparation Example 1

### Manufacture of Anode

An anode having an anion exchange group is manufactured by mixing 1.0 g of polystyrene having an anion exchange group and 20 g of dimethylacetamide (DMAc) to prepare a polymer solution through an aminization reaction, adding 6.0 g of activated carbon powder (a specific surface area=1600 m²/g) and 0.5 g of carbon black (an average diameter=19 nm) thereto to prepare an anion exchange electrode slurry, coating the anion exchange electrode slurry to form a 200 μm-thick coating layer on a conductive graphite sheet (a thickness=380 μm) with a doctor blade, and drying the coating layer at room temperature.

### Preparation Example 2

### Manufacture of Capacitive Deionization Apparatus (CDI)

Each electrode according to Examples 1 to 4 and Comparative Examples 1 and 2 is respectively used as a cathode, the anode according to Preparation Example 1 is used as an anode, and a water-permeable polyamide open mesh is used as a spacer. The graphite plate/anode/spacer/cathode/graphite plate are sequentially stacked and fastened by a screw, manufacturing a capacitive deionization (CDI) apparatus.

### Experimental Example

### Ion Removal Performance Evaluation of Capacitive Deionization Apparatus (CDI)

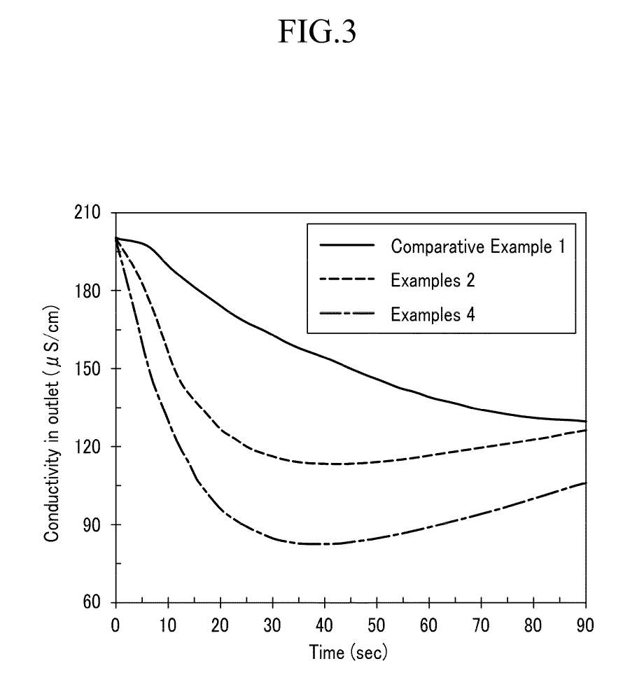

An ion adsorption removal test of each CDI is performed according to the following process, and the results are respectively provided in FIGS. 3 to 5.

The CDI is operated at room temperature and supplied with a 100 ppm NaCl solution (ion conductivity: about 200 μS/cm) at a rate of 50 mL/min.

A cell voltage (a difference between anode and cathode potentials) of 1.5 V is applied for 2 minutes 30 seconds by connecting a power source to each electrode to deionize the cell.

Conductivity of water discharged through the CDI is measured by using a flow-type sensor in real time.

The amount of the charge at each step is measured from the amount of current supplied from the power source.

Discharge (reproduction): 100 ppm NaCl sufficiently flows in the CDI unit cell until no current flows (i.e., until the amount of charge used during deionization is all discharged, for example, for 10 minutes). Herein, the flow is performed at a flow rate of 10 mL/min and a voltage of 0 V.

Ion removal rate (%) of the CDI is obtained from the ion conductivity according to the following formula:

Ion removal rate(%)=(conductivity of inflow water−conductivity of outflow water)/(conductivity of inflow water)*100

FIG. 3 is a graph showing conductivity change depending on time when deionization is performed by using the electrodes according to Examples 2 and 4 and Comparative Example 1. The cathodes according to Examples 2 and 4 show remarkably reduced conductivity depending on time during the deionization compared with the cathode according to Comparative Example 1, and thus have improved ion removal efficiency.

FIG. 4 is a graph showing comparison of each normalized amount of removed ions per active material unit (an organic clay material and activated carbon) by using the amount of ions removed per cycle depending on the amount of organic clay in an active material. In other words, the cathodes respectively including the organic clay in an amount of about 11.80 wt % and about 23.50 wt % according to Examples 2 and 3, respectively, show more ion removal than the cathode including the organic clay in an amount of about 5.90 wt % based on the total weight of the organic clay material and activated carbon according to Example 1. In other words, the more organic clay is used, the more ions per active material unit are removed unless the amount of the organic clay material exceeds 40% of the total weight of the active material in an electrode.

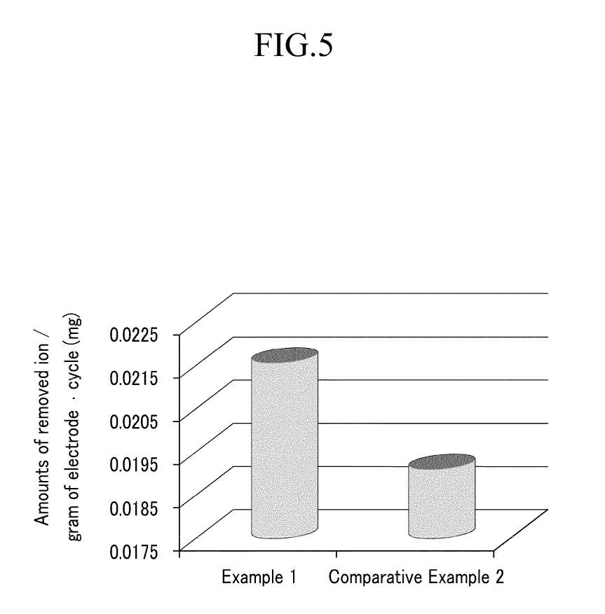

FIG. 5 is a graph showing comparison of the amount of removed ions per unit cycle of a capacitive deionization apparatus respectively including the cathodes according to Example 1 and Comparative Example 2 and per active material unit with the amount of removed ions. In addition, each measurement is provided in the following Table 1.

TABLE 1

| | | Comparative |
|---|---|---|
| | Example 1 | Example 2 |
| Amount of removed ions per unit cycle/ | 0.02155 mg | 0.019086 mg |
| weight of an electrode material | | |

Referring to Table 1 and FIG. 5, the capacitive deionization apparatus including an electrode including an organic clay material shows a much higher amount of removed ions per unit cycle than the capacitive deionization apparatus including an electrode including a conventional clay material.

While this disclosure has been described in connection with various example embodiments, it is to be understood that the present disclosure is not limited to the disclosed embodiments, but, on the contrary, is intended to cover various modifications and equivalent arrangements included within the spirit and scope of the appended claims.

What is claimed is:

1. An electrode material for a capacitive deionization apparatus (CDI) comprising:
a porous carbon material; and
an organic clay within the porous carbon material.

2. The electrode material of claim 1, wherein the porous carbon material is at least one of activated carbon, an aerogel, carbon nanotubes (CNT), mesoporous carbon, activated carbon fiber, and graphite oxide.

3. The electrode material of claim 1, wherein the organic clay comprises a layered structure having a cation exchange capacity, and the organic clay is modified by a water-soluble organic material having an ion exchange functional group.

4. The electrode material of claim 1, wherein the organic clay is smectite-based, vermiculite-based, mica, or a mixture thereof modified by an organic material having a cation exchange group or an anion exchange group.

5. The electrode material of claim 4, wherein the cation exchange group is a sulfonic acid group, a carboxyl group, a phosphonic group, a phosphinic group, an arsenic group, a selenonic acid group, or a combination thereof.

6. The electrode material of claim 4, wherein the anion exchange group is a quaternary ammonium salt (—NR₃), a primary amine (—NH₂), a secondary amine (—NHR), a tertiary amine (—NR₂), a quaternary phosphonium group (—PR₄), a tertiary sulfonium group (—SR₃), or a combination thereof.

7. The electrode material of claim 1, wherein the organic clay is present in an amount of less than or equal to about 40 wt % of a total weight of the electrode material.

8. The electrode material of claim 1, further comprising:
a conductive material, a binder, or a combination thereof.

9. The electrode material of claim 8, wherein the conductive material is at least one of a carbon-based material selected from carbon black, VGCF (vapor growth carbon fiber), natural graphite, artificial graphite, acetylene black, ketjen black, and carbon fiber; a metal powder or a metal fiber selected from copper, nickel, aluminum, and silver; a conductive polymer; and a mixture thereof.

10. The electrode material of claim 8, wherein the binder is at least one selected from polystyrene, polyvinyl alcohol, carboxylmethyl cellulose, hydroxypropyl cellulose, polyvinyl chloride, carboxylated polyvinyl chloride, polyvinyl fluoride, polyimide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, polyacrylamide, and a mixture thereof.

11. An electrode for the capacitive deionization apparatus comprising the electrode material of claim 1.

12. The electrode of claim 11, wherein the electrode is a cathode for the capacitive deionization apparatus.

13. The electrode of claim 11, further comprising:
an ion exchange polymer coating a surface of the electrode.

14. The electrode of claim 13, wherein the ion exchange polymer is a polymer including a cation exchange group or an anion exchange group at a main chain or a side chain thereof, the cation exchange group selected from a sulfonic acid group (—SO₃H), a carboxyl group (—COOH), a phosphonic group (—PO₃H₂), a phosphinic group (—HPO₃H), an arsenic group (—AsO₃H₂), and a selenonic acid group (—SeO₃H), the polymer selected from at least one of polystyrene, polyvinyl alcohol, carboxylmethyl cellulose, hydroxypropyl cellulose, polyvinyl chloride, carboxylated polyvinyl chloride, polyvinyl fluoride, polyamide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, polyacrylamide, and a mixture thereof, the anion exchange group selected from a quaternary ammonium salt (—NR₃), primary to tertiary amine groups (—NH₂, —NHR, and —NR₂), a quaternary phosphonium group (—PR₄), and a tertiary sulfonium group (—SR₃).

15. A capacitive deionization apparatus comprising:
the electrode of claim 11 as a first electrode;
a second electrode having an opposite polarity to the first electrode; and
a spacer disposed between the first and second electrodes.

16. The capacitive deionization apparatus of claim 15, wherein the spacer is an open mesh, a non-woven fabric, a woven fabric, or a foam.

17. The capacitive deionization apparatus of claim 15, further comprising:
a charge barrier disposed between the first electrode and the spacer and between the second electrode and the spacer, the charge barrier including different materials from the electrode material.

18. A method of removing ions from a fluid, comprising:
providing a capacitive deionization apparatus including the electrode of claim 11 as a first electrode, a second electrode having an opposite polarity to the first electrode, and a spacer disposed between the first and second electrodes; and
applying a first voltage to the first and second electrodes while the capacitive deionization apparatus is supplied with the fluid including the ions.

19. The method of claim 18, further comprising:
releasing ions adsorbed from the fluid by short-circuiting the first and second electrodes or by applying a second voltage in a reverse direction between the first and second electrodes.
